(19) United States
(12) Patent Application Publication
(10) Pub. No.: US 2011/0054976 A1
(43) Pub. Date: Mar. 3, 2011

(54) Scheduling Recurring Calendar Events

(75) Inventors: Scott Adler, Saratoga, CA (US); Lala Dutta, Cupertino, CA (US); Angela Elodia Angelone, Sunnyvale, CA (US); Patrick Coffman, San Francisco, CA (US)

(73) Assignee: Apple Inc.

(21) Appl. No.: 12/547,936

(22) Filed: Aug. 26, 2009

(51) Int. Cl. G06Q 10/00; G06F 15/16

(52) U.S. Cl. 705/9; 709/206

(57) ABSTRACT

Methods, systems, and computer-readable media for scheduling a recurring event are disclosed. When a calendar application receives an invitation from an organizer to an invite, the calendar application expands the recurring event into a plurality of occurrences, and detects any scheduling conflicts that can be caused by each of the plurality of occurrences. The calendar application notifies the invitee of the detected scheduling conflicts before the invitee makes a decision regarding the invitation. An invitee is provided an opportunity to accept only the non-conflicting occurrences of the recurring event. If the invitee chooses to accept only the non-conflicting occurrences, the invitee is given opportunities to respond to each of the conflicting occurrences separately. The organizer is notified of the invitee's responses regarding the non-conflicting occurrences and the conflicting occurrences.

### TECHNICAL FIELD

This subject matter is generally related to electronic calendars.

### BACKGROUND

Electronic calendars are becoming an indispensible tool for modern life. Users enter calendar items such as meetings, appointments, and important dates into their electronic calendars to remind themselves of these various engagements at specific times. An organizer of an event can send out electronic invitations for the event to multiple invitees via emails, calendar tools, instant messages, or other communication interfaces. The invitees can accept or decline these invitations based on their availability and inclinations. An accepted invitation is automatically entered into the invitee's electronic calendar as a calendar item for the event. A notification of the acceptance can be sent to the organizer. A reminder can be generated for the organizer and the invitees close to the date and time of event.

A calendar tool can also be utilized to manage reservations for event venues by administrators of the event venues. Each event venue can be assigned a respective calendar, and reservation requests for the event venue can be sent to the calendar in the form of an event invitation. An administrator of the event venue can accept or decline the reservation request based on the availability and suitability of the event venue.

A calendar invitation usually specifies a time window for an event. An invitee can look in his/her own calendar(s) to see if another event has already been scheduled for that time window before accepting the invitation. Some events are recurring events having multiple occurrences. The multiple occurrences can be specified in the invitation using a recurrence frequency or a formula (e.g., every third Monday of the month for six months, starting Jan. 1, 2009, except for Mondays that fall on a holiday). For a recurring event having many occurrences over a long period of time, it is time consuming and cumbersome for an invitee to figure out the exact time windows for each occurrence of the recurring event and to investigate whether an existing calendar item already occupies the time window.

Conventionally, an invitee is only given a choice to either accept or decline an invitation for a recurring event as a whole. This wholesale acceptance or rejection of a recurring event makes it very difficult for an organizer to schedule a recurring event. In one scenario, the organizer is challenged to find a recurrence frequency that would accommodate every invitee's schedule because an invitee has to reject the entire invitation if just one occurrence of the event conflicts with an existing calendar event of the invitee. In the alternative scenario, an invitee can accept a recurring event as a whole despite a known scheduling conflict for an event occurrence, and the organizer does not become aware of this conflict until being faced with the absence of the invitee on the date of that event occurrence.

In many instances, a user accepts an invitation to a recurring event without being aware of the scheduling conflicts that exist in the future, because it was not practical for the user to verify his/her availability for each occurrence in the recurring event. In such cases, the user has to subsequently deal with a double booking situation and reschedule events with a short notice.

In cases for venue reservation, an administrator who unknowingly accepted conflicting reservation requests would face the particular troublesome and difficult task of managing a double booking situation and annoyed venue users. Double booking also causes disruption of work flow and wastes valuable time in an organization.

### SUMMARY

Systems, methods, and computer-readable media for collecting scheduling recurring calendar events are disclosed.

In one aspect, a computer-implemented method is disclosed. The computer-implemented method includes: presenting an invitation for a recurring event, the recurring event comprising a plurality of occurrences; detecting scheduling conflicts for one or more of the plurality of occurrences with one or more existing events in a calendar; and requesting a user to select between a first option to accept all occurrences and a second option to accept only non-conflicting occurrences of the recurring event, the non-conflicting occurrences being the occurrences that cause no scheduling conflicts in the calendar.

In some implementations, the method further includes: upon receiving the user's selection of the first option, inserting all occurrences of the recurring event into the calendar. In some implementations, the method further includes: prior to inserting all occurrences of the recurring event into the calendar, presenting a preview of the detected scheduling conflicts.

In some implementations, the method further includes: upon the user's selection of the second option, inserting only the non-conflicting occurrences of the recurring event into the calendar. In some implementations, the method further includes: sending a response to an organizer of the recurring event, the response indicating that only the non-conflicting occurrences of the recurring event have been accepted. In some implementations, the method further includes: presenting a respective notification for each of the one or more occurrences that cause scheduling conflicts in the calendar, where the notification presents a preview of a respective schedule conflict for the occurrence. In some implementations, the method further includes: receiving, through the notification for one of the one or more occurrences, user input individually accepting the occurrence. In some implementations, the method further includes: receiving, through the notification for one of the one or more occurrences, user input individually rejecting the occurrence. In some implementations, the method further includes: receiving, through the notification for one of the one or more occurrences, user input individually suggesting an alternative time for the occurrence.

In some implementations, the invitation for the recurring event represents a reservation request for an event venue.

In one aspect, a method includes: sending an invitation for a recurring event, the recurring event comprising a plurality of occurrences; receiving a first response accepting a proper subset of all occurrences of the recurring event; receiving a second response for one of the remaining occurrences of the recurring event, the second response being one of accepting the occurrence, rejecting the occurrence, or holding the occurrence for further consideration; and presenting the first and the second responses in a calendar including the recurring event.

In one aspect, a method includes: receiving an invitation for a recurring event from an organizer to an invite, the invitation specifying a recurrence frequency; expanding the recurring event into a plurality of occurrences according to the specified recurrence frequency for the recurring event; detecting scheduling conflicts for one or more of the plurality of occurrences with one or more existing events in a calendar of the invitee; sending the invitation for the recurring event to the invitee; and notifying the invitee of the scheduling conflicts for the one or more occurrences.

In some implementations, the method further includes: receiving a first response from the invitee accepting a proper subset of all occurrences of the recurring event, the proper subset being the occurrences that do not cause scheduling conflicts in the calendar of the invitee; and sending the first response to the organizer. In some implementations, the method further includes: sending an individual notification to the invitee for each of the one or more occurrences that cause scheduling conflicts in the calendar of the invite, where the notification presents a preview of a respective scheduling conflict for the occurrence. In some implementations, the method further includes: receiving a second response from the invitee for one of the one or more occurrences in response to the individual notification for the occurrence, the second response being one of accepting the occurrence, rejecting the occurrence and holding the occurrence for further consideration; and sending the second response to the organizer. In some implementations, the calendar of the invitee integrates multiple sources of availability information for the invitee. In some implementations, the recurrence frequency has an associated time period, and the expanding is performed for the associated time period.

In some implementations, the detecting step further includes: detecting an overlap in schedule time between one of the one or more occurrences and one of the one or more existing events in the calendar of the invitee; and determining that the occurrence of the recurring event and the existing event are incompatible with each other during the overlap in schedule time.

In various implementations, the methods and systems disclosed in this specification may offer one or more of the following advantages.

A calendar application (client or server side, or both) automatically determines if any scheduling conflicts would be caused by each occurrence of a recurring event in a calendar invitation. The calendar application automatically generates a list of occurrences that would cause scheduling conflicts with existing events in an invitee's calendar. The detection of scheduling conflicts can be based on the invitee's availability information integrated from multiple calendars or sources. The detection of scheduling conflicts can also cover a long period of time (e.g., a period of time longer than an invitee is likely to review in his/her calendar before accepting an invitation).

When the invitation for the recurring event is sent to an invitee or an administrator of an event venue, the invitee is also notified of all the scheduling conflicts that would be caused by this recurring event. So the invitee does not have to look at his/her own calendar or multiple calendars to figure out the exact time window for each occurrence of the recurring event, and to investigate whether an existing event already occupies that time window. This provides convenience and efficiency for the invitee and/or administrator to make an informed decision regarding a recurring event, rather than to accept or reject an invitation haphazardly as a whole.

In addition, the invitee or the administrator is presented with a choice to accept all occurrences of the recurring event or to accept only the occurrences of the recurring event that do not cause conflicts. The invitee or the administrator is provided with a notification for each of the conflicting occurrences apart from the notification for the entire recurring event, so that the invitee can make an individualized decision regarding each of the conflicting occurrences. The individual notifications can also provide detailed information of the scheduling conflict between the occurrence and an existing event, so the invitee or organizer can choose to keep, reschedule, or cancel the existing event based on the nature of the existing event. Because the scheduling conflict is discovered and made known to the invitee early on, the invitee or administrator can deal with the conflict more gracefully and easily.

In addition, the event organizer or requester for event venue is notified that only some of the occurrences are accepted by an invitee. So the organizer or requester for event venue is given an opportunity to schedule the remaining (unaccepted or pending) occurrences separately, rather than having to specify a new recurring frequency that is nonetheless likely to cause conflicts in some occurrences. Since rescheduling a smaller number of occurrences is an easier task than rescheduling the whole recurring event, the chance of success in finding a suitable time for each occurrence of the recurring event can be greatly improved.

The details of one or more embodiments of the subject matter described in the specification are set forth in the accompanying drawings and the description below. Other features, aspects, and advantages of the subject matter will become apparent from the description, the drawings, and the claims.

### DESCRIPTION OF DRAWINGS

FIG. 1 is an example user interface for an organizer to send an invitation for a recurring event.

FIG. 2 is an example user interface for notifying an invitee of an invitation for a recurring event.

FIG. 3 is an example user interface element for notifying an invitee of potential conflicts caused by a recurring event, and allowing the invitee to choose between accepting all occurrences of a recurring event or only the non-conflicting occurrences.

FIG. 4 is an example user interface for separately notifying an invitee of each conflicting occurrences for a recurring event.

FIG. 5 is an example user interface for an organizer showing the statuses of invitees for each occurrence of a recurring event.

FIG. 6 illustrates an example system for facilitating the scheduling of a recurring event between an organizer and an invitee.

FIG. 7 is a flow diagram of an example process for scheduling a recurring event by an invitee.

FIG. 8 is a flow diagram of an example process for scheduling a recurring event by an organizer.

FIG. 9 is a flow diagram of an example process for a server facilitating the scheduling of a recurring event between an organizer and an invitee of the recurring event.

FIG. 10 is a block diagram of two example computer systems.

### DETAILED DESCRIPTION

### Example User Interfaces for Scheduling a Recurring Event

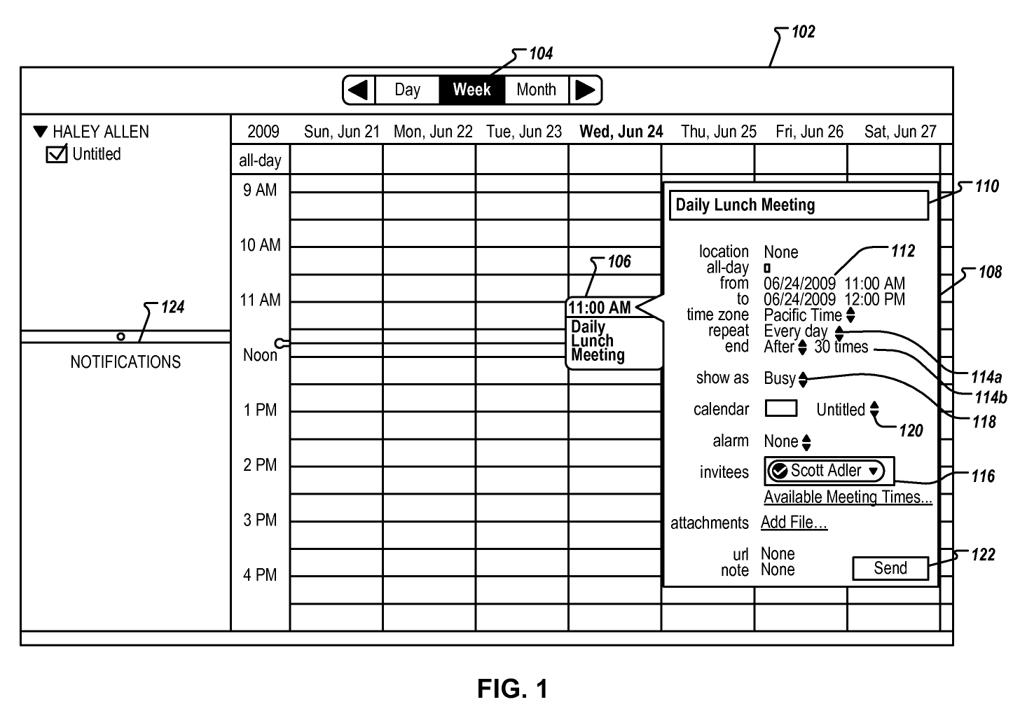

FIG. 1 is an example user interface 102 for scheduling a recurring event by an organizer of the recurring event. The user interface 102 can be for an electronic calendar application or a web interface of a calendar server. The user interface 102 can be provided to the organizer on a computing device, such as a personal computer, a handheld computer, a personal digital assistant (PDA), a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In FIG. 1, the calendar interface is set to a “week” view (e.g., as indicated by the highlighted user interface element 104). Under the “week” view, the organizer's calendar for the current week can be displayed in the calendar interface. The name of the calendar's owner (e.g., the organizer) can be indicated on the calendar interface (e.g., Haley Allen).

The organizer can schedule an event through the calendar interface. User interface element 106 can be inserted into the calendar at the scheduled time window for the event. For example, the organizer can double click on the desired time window in the calendar and enter the event into that time window. The organizer can further specify additional information for the event in an expanded user interface element 108 (e.g., a popup window). For example, the organizer can specify the subject of the event (e.g., “Daily Lunch Meeting”) in user interface element 110. The organizer can also specify and/or modify the location of the event in the expanded user interface element 108, whether the event is an all-day event, the start and end time for the event (112), the time zone of the scheduled time, etc. In some implementations, the organizer of the calendar event can also include attachments (e.g., files and other information) with an invitation to send to the invitees.

In some implementations, if the organizer manages multiple calendars (e.g., home, work, school, etc.) through the same calendar application or web interface, the organizer can also specify the calendar in which the event should be inserted (e.g., in user interface element 120). In some implementations, the owner can also specify whether an alarm or reminder needs to be set for this event.

For a recurring event (e.g., a daily lunch meeting), the organizer of the recurring event can also specify a recurrence frequency (as shown by user interface elements 114a and 114b ) of the recurring event. In this particular example, the repetition rate is every day (as shown by user interface element 114a ) and the total number of occurrences is 30 (as shown by user interface element 114b ). A recurring event has at least two occurrences, while a non-recurring event has only a single occurrence.

Other ways of specifying the recurrence frequency is possible. Examples of a recurrence frequency can include a repetition rate, e.g., “Every day,” “Every Monday of the month,” “Every 15^{th} day of the month,” “every three days,” and so on. The recurrence frequency can also specify a total number of occurrences or a date for the last recurrence. Other more sophisticated formulae can be used to specify the recurring frequency, e.g., “Every Friday that is also the 13^{th} day of the month,” and so on. The recurrence frequency can also specify one or more exceptions. For example, a recurrence frequency can be specified as “Every Monday unless it falls on a public holiday”, or “Every 15^{th} of the month unless it is a weekend” and so on. The recurrence frequency can also include alternative days, e.g., “Every week, on Monday for odd number occurrences, and on Tuesday for even number occurrences.” The recurrence frequency that includes exceptions can also specify an alternative date for the exceptions. For example, the recurrence frequency can be “Every Monday unless it falls on a public holiday, and if the Monday falls on a public holiday, the event takes place on the first day following the holiday.” Other formats for the recurrence frequency are possible. The format can be dictated by the calendar system and the organizer can specify the recurrence frequency according to the format.

The event organizer can also specify a type for the event (e.g., by indicating the event as a “busy” event using user interface element 118). A “busy” event is an event that is incompatible with another “busy” event, i.e., they cannot feasibly occur at the same time. For example, an appointment cannot be made at the same time as another appointment. If two “busy” events are scheduled for the same time, they are conflicting events to each other. On the other hand, an appointment may be feasibly scheduled during a calendar event that simply denotes an important date or a holiday (e.g., a date can be scheduled on a Valentine's Day). Other event types can be specified, such as personal, business, travel, interview, errands, vacation, holiday, available, unavailable, and so on. The calendar system can use the event type information to determine whether two events may conflict with each other.

In some implementations, the calendar system can specify the compatibility between different event types or allow a user to specify the compatibility between event types. For example, the calendar system can specify that the “busy” event type is incompatible with any other event types. A user can specify that the “vacation” event type is compatible with the “personal” event type, but incompatible with the “business” event type. In some implementations, an organizer of an event can specify in the invitation itself the event's compatibility with other types of events. The compatibility information can be used to determine whether two events may conflict with each other.

In addition to inserting an event into one's own calendar, the organizer can also specify a number of invitees to the event (e.g., using user interface element 116). In this example, the event organizer specifies an invitee (e.g., Scott Adler) for the recurring event (e.g., daily lunch meeting). The organizer can specify the invitees by selecting contacts from an address book or by specifying contact addresses (e.g., email addresses) of the invitees. In some implementations, the organizer can also view the availability of an invitee through a link, provided that the invitee allows such information to be shared with the organizer.

After the event organizer finishes specifying the information for the recurring event (e.g., through the user interface element 108), the recurring event is entered into the organizer's own calendar. The organizer can send the invitation for the recurring event to the invitees specified in the event interface 108, for example, by clicking on the user interface element 122 (e.g., a “Send” button). The invitation can be uploaded to a calendar server and forwarded to the invitees via email calendar invitations, notifications, instant messages, or other communication mechanisms.

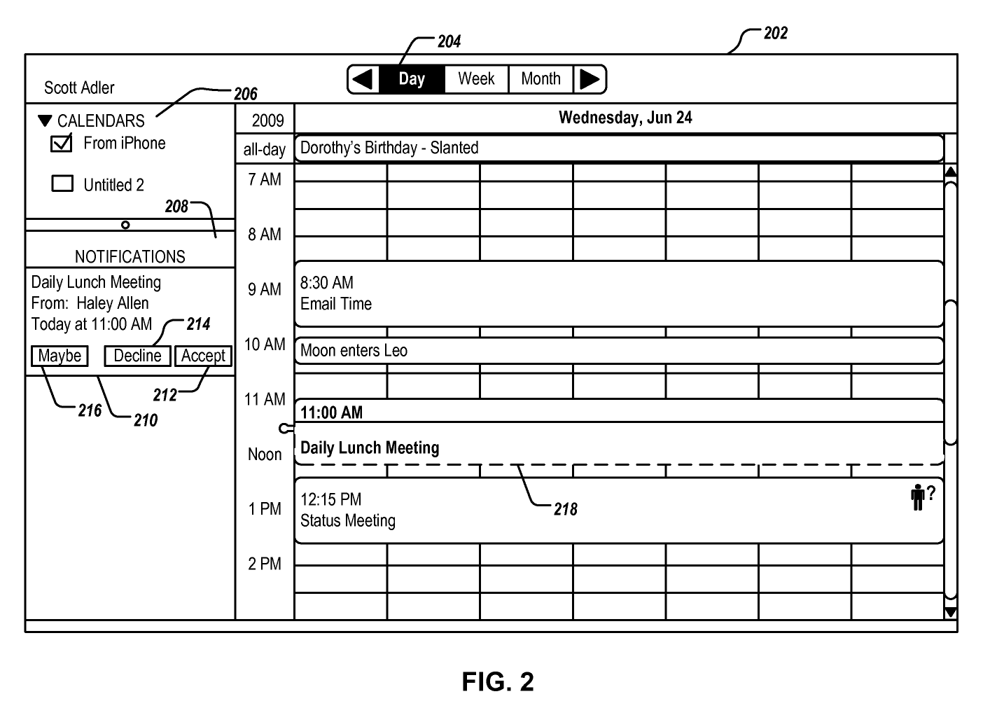

FIG. 2 is an example user interface for an invitee to respond to an invitation for a recurring event received from an organizer of the event. Continuing with the example in FIG. 1, the invitee receives a notification for the invitation for the recurring event (e.g., the daily lunch meeting) in the invitee's calendar interface. Other means for displaying the invitations are possible. For example, in some implementations, the notification for the invitation can be presented in an email message, or a popup reminder window, etc. In this example, the invitation is presented as notification 210 in a dedicated notification window 208 of the calendar interface 202. The notification area is commonly used to present reminders and other notifications that require the user's prompt input or responses.

The notification for the invitation can show the subject, organizer, and time of the event. In this example, the invitation is for a recurring event (“daily lunch meeting”), the notification 210 shows the time for the first recurrences (e.g., Today at 11:00 AM). The notification 210 can present a number of user interface elements 212, and 214 (e.g., the “Accept” and “Decline” buttons) for accepting or declining the invitation. The notification 210 can also present a user interface element 216 (e.g., a “Maybe” button) for entering a tentative decision to accept or decline the invitation.

In this example user interface 202, the calendar is set to the “Daily” view (as indicated by the highlighted user interface element 204), and the date is for the current day. The invitee's schedule for the current day shows a number of items or events of various natures (e.g., reminder for important dates, chores, event of interest, business meetings, deadlines, social engagements, etc.). For example, in the calendar for the current day, there is an all-day event, “Dorothy's Birthday”; a time window blocked out for emailing; a time window denoting a significant event in nature (e.g., “Moon enters Leo”); and a time window scheduled for a status meeting. For the recurring event, a preview of a first occurrence of the recurring event is displayed in the calendar. The time window 218 for the first occurrence is highlighted in dashed lines in this example user interface 202, indicating that this is an event that has not been formally entered into the calendar. The preview can allow the invitee to see whether the event (in this case, the first occurrence of a recurring event) fits well into the existing schedule of the day.

In this example, the first occurrence of the recurring event does not conflict with any other existing event for the day. Conventionally, unless the invitee tries to figure out the time windows for the rest of the recurrences and look at the schedule for those dates, the invitee has to make a decision regarding the invitation based on the knowledge of the first occurrence only. Since the first occurrence does not create a conflict, the invitee is likely to proceed to accept the recurring event, unless the invitee is unwilling to accept the invitation for other reasons.

In this example, if the invitee clicks on the “Decline” button 214 in the notification 210, the invitation as a whole is declined, and the event is not entered into the invitee's calendar. The notification 210 is dismissed from the calendar interface 202, and the preview of the event in the calendar is removed as well. The user's decision to decline is sent to the organizer.

In this example, if the invitee clicks on the “Maybe” button 216, the user's decision to hold the invitation for more consideration can be sent to the organizer of the event. In some implementations, the user selecting the “Maybe” button 216 can cause an additional user interface to appear that allows the user to browse through the different occurrences and see how the event fits into the schedules of the dates of those occurrences. In some implementations, when the user selects the “Maybe” button 216, the all occurrences of the recurring event can be tentatively entered into the invitee's calendar, and a reminder can be sent to the invitee closer to the date of each occurrence of the recurring event. The decision for tentatively accepting or declining the event can be sent to the organizer of the event.

In some implementations, the invitee can have multiple calendars shown in the calendar interface. The user can select one or more of the multiple calendars to display in the calendar interface 202 using user interface element 206. The schedule displayed in the calendar interface 202 can be a combined schedule of all selected calendars. In this example, the invitee has selected one calendar in the user interface element 206.

In this example, the notification is presented in the dedicated notification area 208 in the calendar interface 202. However, the notification of the invitation can be presented in other interfaces as well. For example, the notification can be sent to the invitee via an email message. The email message can include a user interface element or link that allows the invitee to decline or accept the invitation. The email message can also be linked to the calendar information relevant to the invitation. The invitee can interact with the notification without invoking the full-blown calendar functionalities. Other implementations of the notifications are possible.

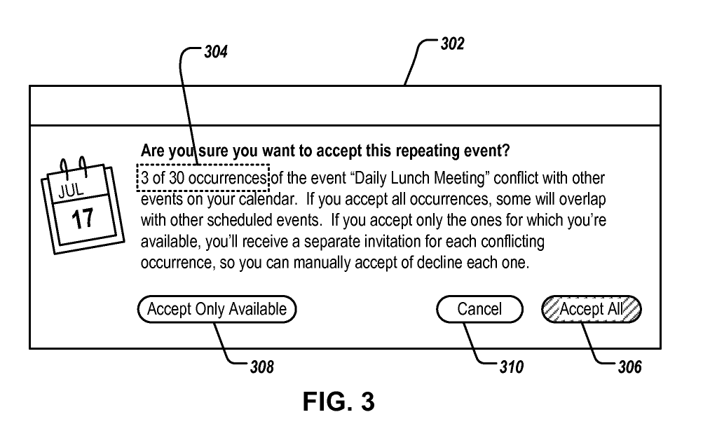

Continuing with the example in FIG. 2, if the invitee selects the “Accept” button 212 to accept the invitation for the recurring event, another user interface element 302 (e.g., as shown in FIG. 3) can be presented. The user interface element 302 is not presented for one-time events, or recurring events that do not cause any scheduling conflicts in the invitee's calendar.

The example user interface element 302 shown in FIG. 3 can notify the invitee of any scheduling conflicts that would be caused by one or more occurrences of the recurring event if the recurring event is accepted as a whole. For example, in this case, the recurring event conflicts with 3 existing events in the invitee's schedule. The user interface element 302 notifies the invitee that 3 of a total of 30 occurrences of the recurring event “daily lunch meeting” conflict with other existing events on the invitee's calendar.

In some implementations, the information presented in the user interface element 302 can be provided by a remote server. The remote server can gather the invitee's availability information from multiple sources. For example, if the invitee has multiple calendars and task lists, etc., the server can gather all the availability information in the multiple calendars and task lists, and determine whether each occurrence of the recurring event conflicts with any existing event in any of the calendars and task lists. The server can provide the scheduling conflicts information to the invitee in the notification. Alternatively, the server can make the determination only after the invitee selects the “Accept” button. In some implementations, the server can make the determination based on the currently selected calendar(s). In some implementations, the determination can be made locally on the invitee's device, provided that the device has access to the invitee's schedule(s) or availability information. In some implementations, the user interface element 302 can be generated locally based on the detected scheduling conflicts. In some implementations, the user interface element 302 can be received from the remote server, for example, through a web interface.

In some implementations, the user interface element 302 not only provides the information regarding the number of occurrences that would cause scheduling conflicts, the user interface element 302 can also provide a choice between accepting all occurrences despite the scheduling conflicts, and accepting only the non-conflicting occurrences (e.g., the occurrences that do not conflict with existing events in the calendar). If the invitee chooses to accept only the non-conflicting occurrences, the invitee can be given an opportunity to deal with the conflicting occurrences (e.g., occurrences that do conflict with one or more existing events in the calendar) separately.

In this example, the user interface element 302 provides two user interface elements 306 and 308, one for accepting all occurrences (e.g., user interface element 306), and the other for accepting only available (e.g., non-conflicting) occurrences. In some implementations, the user can be given an opportunity to preview all the conflicting occurrences before making a decision regarding whether to accept all occurrences and reschedule the existing events that conflict with the recurring event.

In some implementations, the user interface element 302 can provide a narrative that explains to the invitee how to handle the detected scheduling conflicts. In some implementations, the narrative can explain that if the invitee decides to accept all occurrences, some occurrences (e.g., 3 out of 30 in this example) would overlap with other scheduled events in the calendar(s). The narrative can further explain that if the invitee accepts only the ones for which the invitee is available (e.g., the occurrences for which no scheduling conflicts were found), the invitee would receive a separate invitation/notification for each conflicting occurrence, so that the invitee can manually address (e.g., accept or decline) each one of the separate invitations.

If the user selects the “Accept All” user interface element 306, the recurring event is accepted as a whole, all occurrences of the recurring event can be inserted into the invitee's calendar on their respective date and time. A notification of the complete acceptance can be sent to the organizer of the event.

If the user selects the “Accept Only Available” user interface element 308, only the non-conflicting occurrences are inserted into the invitee's calendar. A notification can be sent to the organizer of the event showing which of the occurrences are accepted, and which have not been accepted. Separate invitations for each of the conflicting occurrences can be prepared by a remote server or locally at the invitee's device and the separate applications can be sent to the invitee through the notification window, or other mechanisms.

In some implementations, the user interface element 302 can also allow the invitee to defer the decision till later, e.g., by clicking on the “Cancel” button 310. If the invitee clicks on the “Cancel” button 310, the user interface element 302 can be dismissed, and the invitee can deal with the notification 210 shown in FIG. 2 at a later time.

In some implementations, other options for addressing the invitation can be made available to the invitee. For example, the invitee may be given a choice to accept only available and decline the conflicting occurrences (e.g., by clicking on an “accept available and decline conflicting” button). If the user selects this option, the response is sent back to the organizer, and no separate notification needs to be provided to the invitee later on.

In some implementations, the user interface can provide a choice to preview the date of all occurrences or the conflicting occurrences. If the user selects this choice, another user interface element can be provided for the user to browse through the daily schedule for the dates of those conflicting occurrences. In some implementations, the invitee can also be given an opportunity to provide a proposed new date/time for each or all of the conflicting occurrences in the user interface.

In some implementations, the invitee can be given an opportunity to cancel or move some existing events on those dates to resolve the scheduling conflicts through the user interface. In some implementations, if the user is able to resolve some or all of the scheduling conflicts through the user interface, a new determination can take place, and an updated user interface element 302 can be displayed. For example, if the user canceled or moved one existing event that conflicts with an occurrence of the recurring event, the updated user interface element 302 can state that only 2 of 30 occurrences of the event “daily lunch meeting” conflict with other events on the invitee's calendar.

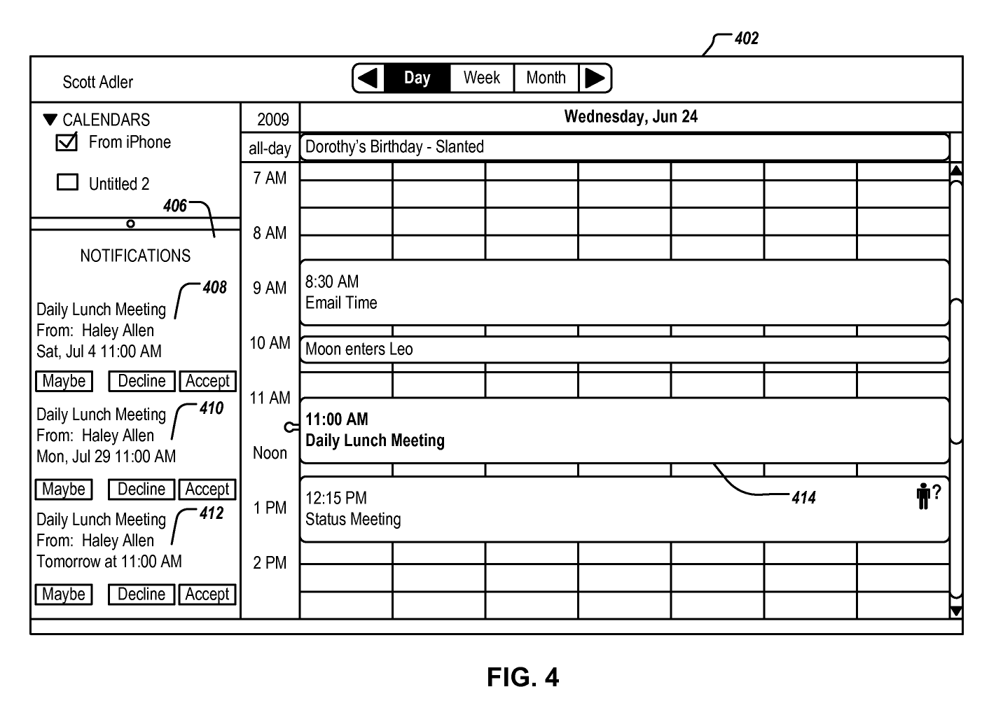

FIG. 4 shows an example user interface 402 for the invitee's calendar after the invitee has selected to accept only the non-conflicting occurrences. In FIG. 4, the non-conflicting occurrences of the recurring event have now been accepted and inserted into the calendar. For example, the first occurrence on June 24 does not conflict with any existing events for that date, and the first occurrence now appears on the invitee's calendar as an accepted and scheduled event 414.

The interface 402 in FIG. 4 also shows that a number of new notifications 408, 410, and 412 have been received, and shown in the dedicated notification area 406. Each notification is presented as a separate invitation for a separate occurrence. For example, each invitation shows the same subject and organizer as the original recurring event. However, each invitation shows a different event date, e.g., the date of the particular occurrence included in the invitation. In this example, the conflicting occurrences are for July 4, July 29, and June 25. The user can deal with each individual invitation as if it were an invitation for a one-time (or non-recurring) event on the occurrence's respective date.

In some implementations, if there are a number of conflicting occurrences, the dedicated notification area 406 can display a scroll bar for browsing through the different invitations for the conflicting occurrences. In some implementations, one invitation is displayed at a time, and more information is displayed within the notification area 406 for each event. For example, the schedule for the date of the conflicting occurrence can be displayed in the separate invitation for the conflicting occurrence. The user can browse through the notifications using a browsing element in the notification area 406.

In some implementations, if the invitee selects the “Maybe” button on the separate invitation for a conflicting occurrence, the calendar entries for the particular date of the conflicting occurrence can be displayed for the user to make a more informed decision. The invitee can accept the invitation for that occurrence after previewing the schedule for the date of the occurrence.

If the user does not decide to accept or decline a particular conflicting occurrence after seeing the preview, a tentative decision to hold the occurrence for further consideration is sent to the organizer. The organizer would be notified that the invitee is undecided about that particular occurrence at this time.

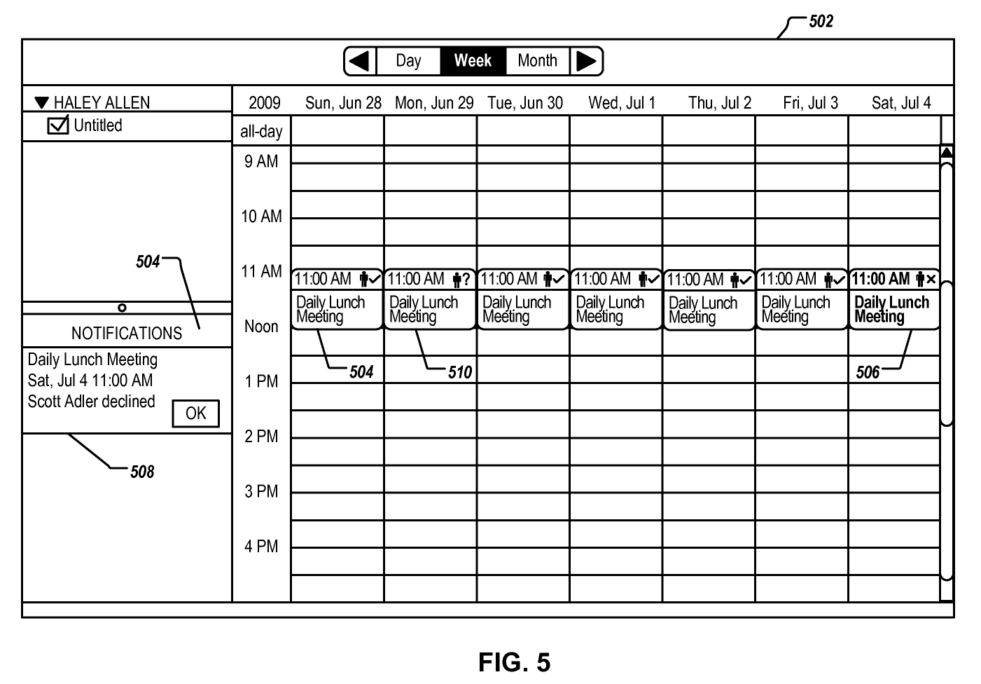

FIG. 5 shows an example user interface 502 for the organizer's calendar after the invitee has made some selection regarding the invitation for the recurring event. In this example, the calendar shows the occurrences of the recurring event in the current week. For the occurrences that the invitee has accepted, an indicator can be displayed on the user interface elements (e.g. 504) for those occurrences showing an “accepted” status (e.g., a checkmark next to the litter person representing an invitee). For the occurrences that the invitee has not accepted or declined, an indicator showing an “undecided” status (e.g., a question mark) can be displayed on the user interface elements for those occurrences (e.g., 510). For the occurrences that the invitee has made individualized decisions to decline, an indicator showing a “declined” status (e.g., a cross) can be displayed on the user interface elements for those occurrences (e.g., 506). In some implementations, the organizer can click on the user interface element for a declined occurrence to propose a new time or to cancel that particular occurrence.

In this example, the notification area 504 also shows a notification 508 of the invitee's rejection of the occurrence on July 4. The organizer can click the “OK” button to acknowledge the receipt of the rejection and dismiss the notification 508. The receipt can be sent back to the invitee if the invitee requests such acknowledgement.

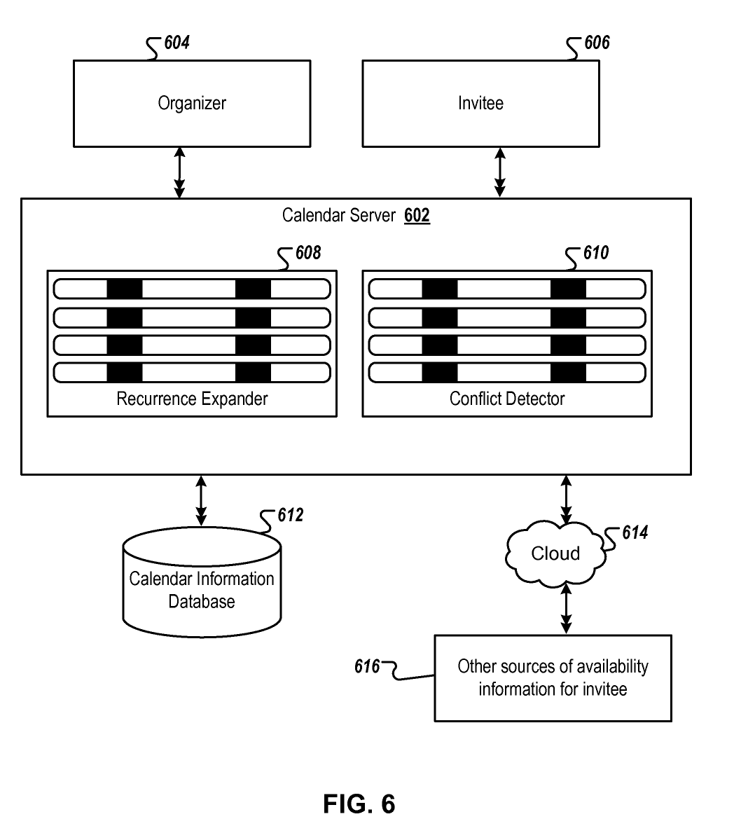

FIG. 6 shows an example system for facilitating the scheduling of a recurring event between an organizer 604 and an invitee 606. The system can implement the delivery of invitations and responses for calendar events to and from users of the system.

In this example, the system includes a calendar server 602. The calendar server 602 can be in communication with a number of users, including the organizer 604 and the invitee 606. The users of the calendar system 602 can set up individual accounts with the calendar server 602. Each account is associated with a user profile and various user data. Each user can also setup multiple calendars (e.g., home, work, social, etc.) with the calendar server. In some implementations, each user can also import external calendars (e.g., user's local calendars, calendars on another device, and calendars on other service providers) to the calendar server 602. In some implementations, each user can also provide authorization information to the calendar server 602 to access external calendars on behalf of the user. The calendar server 602 can store an up-to-date version of these calendars in calendar information database 612. Alternatively, the calendar server 602 can gather the calendar information from various sources 616 as the data is needed, for example, through one or more networks 614.

Each user can be an organizer of an event. When the organizer 604 of an event specifies an event (e.g., start and end time, location, subject, etc.) and the invitees of the event (e.g., by specifying their email addresses, or usernames), the calendar server can receive an invitation from the organizer for the event and deliver the invitation to each specified invitee. The invitation can then be rendered on the invitee's device, for example as a notification in the calendar interface, or as an email notification.

As described in the examples shown in FIGS. 1-5, the calendar server 602 can also gather the availability information of each invite, and determine whether there is any scheduling conflict for the occurrences of the invitation. The calendar server 602 can perform this determination when the invitation is received from the organizer 604 and send the conflict information with the invitation to the invitee 606.

In some implementations, the calendar server 602 can start the process for determining conflicts after the invitee 606 has indicated an inclination to accept the invitation, e.g., by clicking on the “Maybe” button, the “Accept” button, or requested a review of the event's occurrences.

In some implementations, the calendar server 602 can compile a list of the detected scheduling conflicts and send the list to the invitee 604. The list of scheduling conflicts can be rendered on the invitee's device or calendar interface as a notification of the number of occurrences that would cause schedule conflicts. The list of scheduling conflicts can further be rendered on the invitee's device as previews of the dates on which these scheduling conflicts would occur.

In some implementations, the calendar server can include a recurrence expander component 608. The recurrence expander 608 can parse the specified recurrence frequency in an invitation. The recurrence expander 608 can expand a recurring event into a number of occurrences on specific dates (and times) according to the specified recurrence frequency.

As described above with respect to the example in FIGS. 1-5, the recurrence frequency can be specified in various formats. For example, the recurrence frequency can specify a starting date and an end date, or a total number of occurrences. The recurrence frequency can specify a repetition rate, or describe a characteristic of the date on which an occurrence is to occur. For example, the recurring frequency can specify “every three days starting on Jun. 24, 2009” or “all public holidays in year 2009” etc. The recurring frequency can also specify exceptions and alternatives in case of exceptions. For example, the recurrence frequency can specify “every Friday except Fridays that also fall on the 13^{th} of the month” or “every Monday exception for public holidays, and if a Monday falls on a public holiday, then Tuesday.” In some implementations, the recurrence frequency can also specify different recurrence frequency values for different periods, for example, the recurrence frequency can specify “9 am every Monday during the spring months, 8 am every other Monday during the summer months, and 10 am every third Monday during the fall and winter months.” The calendar server 602 can provide different options in a user interface for a user to specify the recurrence frequency according to particular formats accepted by the recurrence expander 608.

In some implementations, the recurrence expander 608 can expand the recurring event received from the organizer 604 into the event's constituent occurrences according to the specified recurrence frequency within the specified time or number limits in the invitation. If no time or number limits are specified in the event invitation itself, the recurrence expander 608 can use a default or user-specified (either by the invitee or the organizer) period (e.g., three months from the first occurrence).

The calendar server 602 can include a conflict detector component 610. The conflict detector component 610 can utilize various mechanisms for detecting overlapping time windows to determine whether a scheduling conflict exists for each occurrence of the recurring event. For example, by comparing the start and end times of the existing events and the start and end time of each occurrence, an overlap in time window can be detected. If an overlap in time window is detected, a potential scheduling conflict can be recorded.

In some implementations, even if there is an overlap in schedule time between an existing event and an occurrence, a scheduling conflict may not exist if the existing event and the occurrence are compatible with each other. Compatibility between two events can be determined based on the nature of the events. In some implementations, an event type can be associated with each event to denote the nature of the event. Compatibility between events can be specified by the compatibility between the events' respective event types. For example, two “busy” type events are not compatible with each other, and cannot be scheduled for the same time. For another example, a “holiday” type event is compatible with a “social” type event, but may not be compatible with a “work” type event.

Many event types can be defined by the calendar system 602 or by the users (e.g., organizer 604 and invitee 606). The compatibility of event types can also be specified by the system 602 or by the individual users.

The event types and compatibility information can be stored by the calendar server 602 and/or associated with each user. In some implementations, event type information can also include location information. Two events may be incompatible with each other if their locations are too far away from each other to be feasibly scheduled for the same day.

In some implementations, if an existing event and an occurrence overlap in time (or are too close in time), and they are of incompatible types, then a scheduling conflict is detected and recorded by the conflict detector 610. The occurrence is recorded in the list of conflicting occurrences.

When the calendar server 602 receives an invitation from the organizer 604 and sent the invitation to the invitee 606, the invitee 606 can respond to the recurring event invitation by accepting all occurrences. If the invitee 606 accepts all occurrences, the acceptance can be sent to the calendar server 602, and the calendar server 602 can forward the acceptance to the organizer 604. The organizer's user interface can be updated accordingly to reflect the acceptance.

If the invitee 606 decides to accept only available (e.g., non-conflicting) occurrences, the partial acceptance can be sent to the calendar server 602, and the calendar server 602 can notify the organizer 604 of the partial acceptance. The user interface for the organizer 604 can be updated accordingly to reflect the partial acceptance. The accepted occurrences can be shown as confirmed, and the unaccepted occurrences can be shown as undecided in the organizer's calendar interface.

If the response from the invitee 606 is for accepting only the non-conflicting occurrences of the recurring event, in some implementations, the calendar server 602 can also formulate individual invitations for each of the conflicting occurrences, and sends the individual invitations to the invitee 606. The individual invitations can be presented to the invitee just like a normal invitation for a one-time (or non-recurring) event. The invitee 606 can accept or decline, or hold the invitation for the individual conflicting occurrence as can be done for an invitation for a normal non-recurring event. When the invitee responds to each of the individual invitations, the calendar server 602 can receive these responses, and forward them to the organizer 604. The calendar interface for the organizer 604 can be updated accordingly. Notifications for the invitee's responses for the conflicting occurrences can be displayed in the organizer's calendar interface as well.

In some implementations, the calendar server 602 can cause the display of the user interfaces shown in FIGS. 1-5. In such implementations, the local devices of the organizer and the invitee can simply render the user interface elements according to the specifications provided by the calendar server 602. In some implementations, some of the computations described for the calendar server can be performed locally on the user's devices, if the information needed for the computation is available on the local device. For example, the determination of scheduling conflict can be performed locally on the invitee's device. Furthermore, the user interface elements for providing the different options for addressing the scheduling conflicts can be generated by the invitee's device as well.

### Responding to an Invitation for a Recurring Event

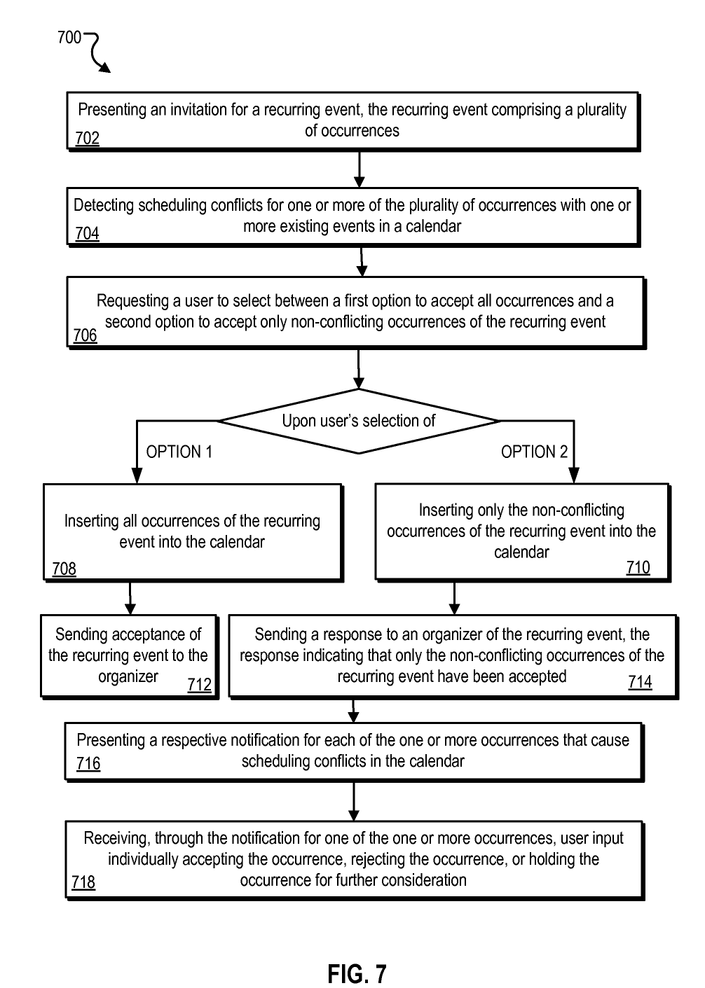

FIG. 7 is a flow diagram of an example process 700 for scheduling a recurring event by an invitee (e.g., responding to an invitation of a recurring event). The example process can be implemented by a client device of the invitee. The process can also be implemented by a server interacting with the invite, for example, through a web interface.

The process can start when an invitation for a recurring event is received from an organizer by an invite. In some implementations, the invitation for the recurring event can be presented (702). The recurring event can include a number of occurrences. The occurrences can be specified explicitly, or by a recurrence frequency. The recurrence frequency can be specified in many different formats. The calendar application or server of the calendar can dictate the format of the recurrence frequency for easy parsing of the recurrence frequency. The invitation for the recurring event can be presented as a notification in a dedicated notification area in the calendar interface. Alternatively, the invitation can be sent to the invitee in an email message which can invoke the calendar interface. In some implementations, the invitation can be presented as a popup window after arriving at the client device or as the user invokes the calendar interface.

In some implementations, the invitation presented to the invitee can include only a subset of all information related to the invitation. For example, a notification for the invitation can include only the organizer, the date and time for the first occurrence, and the subject line of the recurring event. Other information can be presented when the user interacts with the invitation, e.g., by clicking on the notification for the invitation, or mouse over the notification. In some implementations, the user interface element representing the invitation can include a user interface element (e.g., a “Decline” button) for declining the invitation. If the invitation is declined, the response can be sent to the organizer, and the following steps of the process of FIG. 7 may be omitted.

Scheduling conflicts can be detected for one or more of the plurality of occurrences with one or more existing events in a calendar (704). In some implementations, the scheduling conflicts are determined by a calendar server for the invitee and/or organizer. For example, the server can expand the recurring event into individual occurrences according to the recurrence frequency specified in the invitation and a time limit specified by the system, the invite, or the organizer. Each occurrence can have its own start and end time. The start and end time of each occurrence can be compared with the start and end times of existing events in the invitee's calendar. If an overlap is found, and if the recurring event and the existing event within the overlap are of incompatible types, then a scheduling conflict is found between the occurrence and the existing event. The server can record all scheduling conflicts that have been found in a list. The server can also send the scheduling conflict information to the invitee's device, such that the invitee's device can detect such scheduling conflicts.

In some implementations, the invitee's device can determine the scheduling conflicts locally based on the invitee's availability information that is available or accessible locally or remotely. The calendar information can be a locally stored calendar, or calendar information can be downloaded from one or more servers of such information.

If no scheduling conflicts are detected for the recurring event, the invitee can accept or reject the invitation in the same manner as a non-recurring event. However, if scheduling conflicts are detected between some occurrences of the recurring event and existing events in the invitee's calendar, the calendar application or interface can request the invitee to select between a first option to accept all occurrences of the invitation and a second option to accept only non-conflicting occurrences of the recurring event (706). The non-conflicting occurrences are the occurrences that do not have a scheduling conflict with any existing event in the calendar.

The user interface element that requests the invitee's selection between the two options can be triggered after the invitee has shown an inclination to accept the event, for example, by clicking on an “Accept” button on the invitation. Alternatively, the user interface inviting the invitee's selection can be presented when the user interacts with the invitation, e.g., selecting the invitation for more information, etc.

In some implementations, the user interface element requesting the invitee's decision can present additional information, such as the total number of conflicting events out of the total number of occurrences of the recurring event. In some implementations, the user interface element can also present a narrative regarding the option to accept all occurrences, and the option to accept only the non-conflicting occurrences and leaving the conflicting occurrences for separate consideration. For example, the narrative may explain that if the invitee chooses to accept only the non-conflicting occurrences, the invitee would be given an opportunity to respond to each of the conflicting occurrences separately as separate invitations.

In some implementations, the invitee can also be given an opportunity to preview the detected scheduling conflicts. For example, a user interface element can be presented for the invitee to browse through the scheduling conflicts before making a choice between accepting all or accepting only the available (i.e., non-conflicting) occurrences.

Upon receiving the invitee's selection of the first option (e.g., accepting all occurrences of the recurring event), all occurrences of the recurring event are inserted into the calendar (708). Upon the user's selection of the second option (e.g., accepting only the non-conflicting occurrences of the recurring event), only the non-conflicting occurrences are into the calendar (710).

In some implementations, prior to inserting all instances of the recurring event into the calendar, a preview of all scheduling conflicts can be presented to the invitee. A confirmation of the acceptance can be requested after the preview of the scheduling conflicts is presented to the invitee.

After the invitee has made a decision regarding whether to accept all occurrences or accepting only the non-conflicting occurrences, a response is sent to the organizer of the event. If the invitee chose to accept all occurrences despite of the scheduling conflicts, an acceptance of the recurring event is sent to the organizer (712). If the invitee chose to accept only the non-conflicting occurrences, a response is sent to the organizer indicating that only the non-conflicting occurrences of the recurring event have been accepted (714). The response can also indicate that the invitee has not made a final decision regarding the remaining (e.g., conflicting) occurrences. In some implementations, the response can list all the conflicting occurrences (e.g., the date or start/end times of the conflicting occurrences). Alternatively, the response can indicate that the invitation is partially accepted and the calendar server can fill in the information regarding which occurrences have been accepted and which have not.

After the invitee has chosen the option to accept only available (e.g., non-conflicting occurrences), a respective notification for each of the one or more detected conflicting occurrences are presented (716). The respective notification can present a preview of a respective scheduling conflict for the occurrence. The preview can be invoked by the invite, for example, by clicking on the individual notification. In some implementations, the preview of the scheduling conflict can be presented when the user clicks on the “Accept” button presented with the individual notification. In some implementations, after the preview of the scheduling conflict is presented, the invitee can be asked to confirm the acceptance despite of the conflict. In some implementations, the individual notification can present the calendar entries for the date of the conflicting occurrence, and the invitee can interact with the calendar entries to cancel or move the existing calendar entries to resolve the scheduling conflict.

In some implementations, the calendar system also has the capability to detect a scheduling conflict for a non-recurring event. In such systems, the individual notification for each conflicting occurrence can be presented in the same manner as an invitation for a regular non-recurring event. An alert (e.g., a popup window) can be presented to the user indicating the scheduling conflict for that occurrence when the user interacts with the individual notification for that occurrence.

The invitee can interact with each individual notification to accept, reject, or hold the occurrence for further consideration. The user input is received through the individual notification for each of the one or more conflicting occurrences (718). The user input can be for individually accepting the occurrence, individually rejecting the occurrence, individually suggesting an alternative time for the occurrence, or individually holding the occurrence for further consideration.

Although the discussion of the processes and user interfaces are with respect to an invitation to a person for a particular recurring event, the same processes and interfaces can be applied to a reservation request for a particular event venue (or equipment or other items). Each event venue is assigned a calendar account, and the administrator of the event venue has access privilege to accept reservation requests for the event venue. Users making a reservation request for an event venue can send an “invitation” to the event venue as if the event venue were the invitee. In some implementations, the organizer can specify the event venue as a special invitee such that other invitees do not receive the invitation until the special invitee (the event venue) has accepted the invitation.

### Organizing a Recurring Event

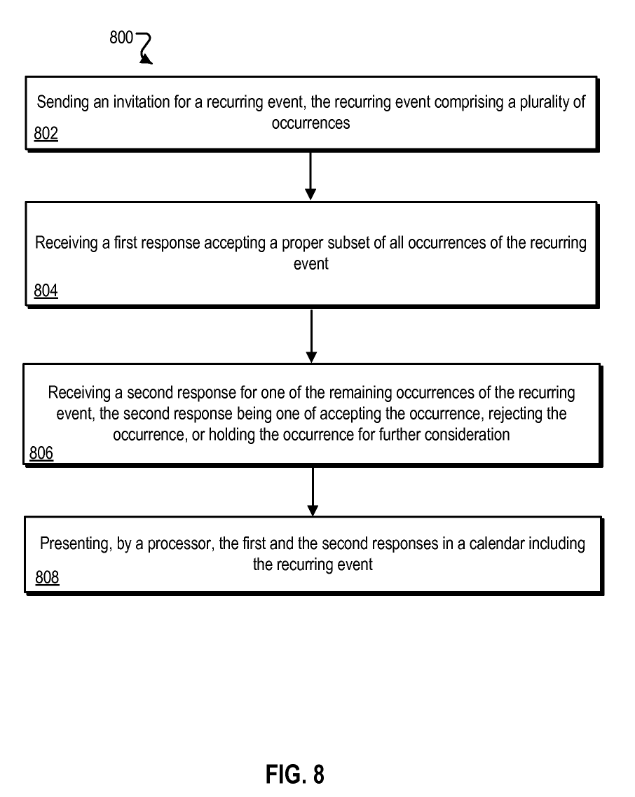

FIG. 8 is a flow diagram of an example process 800 for scheduling a recurring event by an organizer. The example process 800 can be implemented by a client device of an event organizer. The example process 800 can also be implemented by a server interacting with the event organizer, for example, through a web interface.

The process can start when the organizer or client device of the organizer sends an invitation for a recurring event to an invitee (802). The invitation can be specified by the organizer. The recurring event includes a plurality of occurrences. The invitation can specify one or more invitees and a recurrence frequency for the recurring event. In some implementations, the invitation can be sent to a calendar server and forwarded to the invitee by the calendar server.

After the invitation has been sent out, the organizer can receive a first response from the invitee accepting a proper subset of all occurrences of the recurring event (804). A proper subset of all occurrences includes fewer than all occurrences of the recurring event. In some instances, the organizer can receive a notification that all occurrences have been declined by the invitee. In some instances, the organizer can receive a notification that all occurrences have been accepted by the invitee. However, in cases where the invitee has scheduling conflicts for some of the occurrences in the recurring event, it is possible that not all occurrences are accepted by the invitee. A response accepting a proper subset of all occurrences of the recurring event means at least one occurrence among all occurrences of the recurring event was not accepted in this response.

After the invitee has responded to each individual conflicting occurrence, the organizer can receive individual second responses from the invitee for the remaining occurrences of the recurring event (806). Each individual second response can be one of accepting the occurrence, rejecting the occurrence, or holding the occurrence for further consideration.

After one or more responses to the invitation are received from the invite, the responses from the invitee can be presented in a calendar including the recurring event (808). For example, the calendar can provide an indicator on each occurrence of the recurring event in the calendar showing whether the invitee has accepted or declined the invitation for that occurrence, or if the invitee is currently undecided about that occurrence.

In some implementations, the organizer can send out a reminder for the individual occurrences to which the invitee has not responded after a predetermined period of time. In some implementations, the organizer can send out alternative proposed times for the occurrences that the invitee has declined or is holding for further consideration.

### Communications Between an Organizer and an Invitee of a Recurring Event

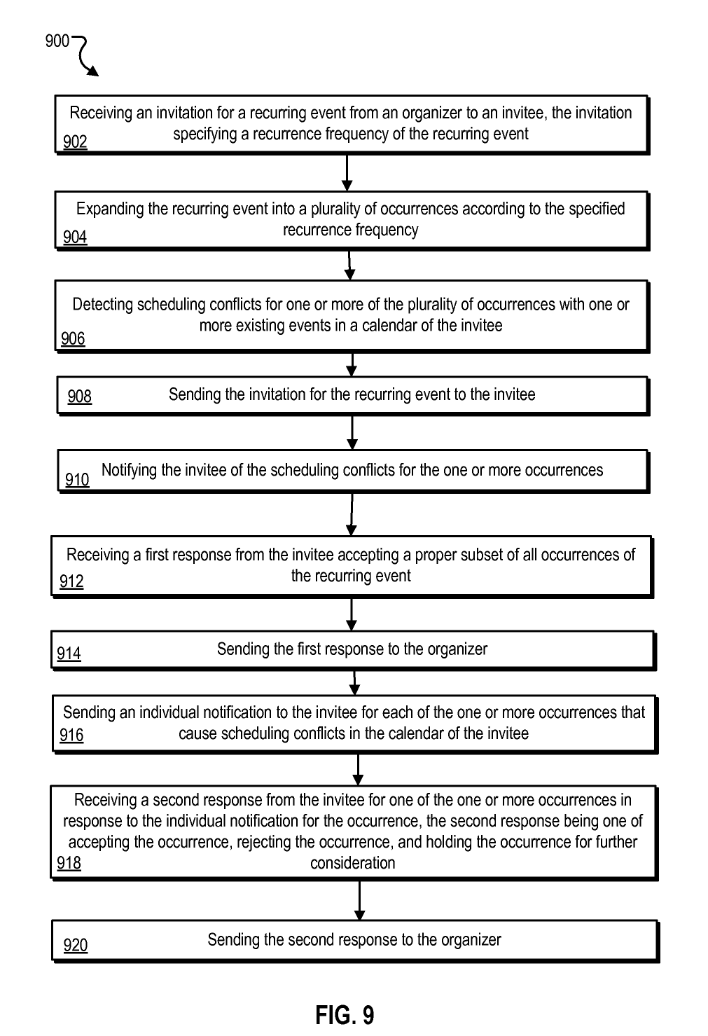

FIG. 9 shows a flow diagram of an example process 900 for a server facilitating the scheduling of a recurring event between an organizer and an invitee of the recurring event.

First, an invitation for a recurring event from an organizer to an invitee is received, for example, by a calendar server (902). The invitation can specify a recurrence frequency. The server can expand the recurring event into a plurality of occurrences according to the specified recurrence frequency for the recurring event (904).

The server can further gather availability information for the invitee. The availability information can be gathered from the invitee's calendar(s) hosted by the server and other calendars that the invitee has granted the server access to (e.g., calendars hosted by a different server, on a mobile device, or on a remote user device, etc.). The server can detect scheduling conflicts for one or more of the plurality of occurrences of the recurring event with one or more existing events in the calendar of the invitee (906). The calendar can be an integrated calendar of the user's availability information from multiple sources (e.g., multiple calendars, schedules, etc.).

The server can detect the scheduling conflict by various methods. For example, the server can detect an overlap between the time windows of each occurrence and each existing event in the invitee's calendar. The time window can be specified by the start time and end time of the occurrence or existing event. In some implementations, the scheduling conflict is found only between overlapping events that are of incompatible event types. Event types and compatibility of event types can be defined by the system, the invite, or the organizer. For example, an event type can be a simple parameter or flag that specifies “busy” or “not busy.” Two events of the “busy” type are incompatible; and if they overlap in time, they create a scheduling conflict. If at least one of the two events is of the “not busy” type, then the two events are compatible. If the two compatible events overlap in time, they do not create a scheduling conflict. In another example, an “all-day” event may be compatible with a daily meeting that takes a very short time (e.g., a “5-min meeting”).

The event type definitions and compatibility information between event types can be stored in a database that is accessible by the system that determines the scheduling conflicts. There can be default event types that a user can select to associate with each particular calendar event or item. In addition, a user interface can be provided by the calendar system for users to define custom event types, and specify compatibility of the customized event type with other existing event types in the database.

In some implementations, the detection of conflicts is not conducted by the server. A device of the invitee can perform the check locally based on information available to the device. Therefore, some steps in FIG. 9 can be performed by a device of the organizer or of the invitee.

After the invitation for the recurring event is received by the server from the organizer, the server can send the invitation for the recurring event to the invitee (908). In some implementations, the server sends the information to a device of the invitee through an email. In some implementations, the server sends the invitation to the invitee through a notification in a calendar interface. Other means of notification of the invitations can also be employed.

After the server sends the invitation to the invite, the server can also notify the invitee of the scheduling conflicts for the one or more occurrences that have been detected (910). In some implementations, the notification of the scheduling conflicts can be triggered when the invitee interacts with the invitation to accept the invitation. In some implementations, the notification of the scheduling conflict can be triggered when the invitee is presented with the invitation. In some implementations, the server can also present a user interface for the invitee to browse through the scheduling conflicts.

After the scheduling conflicts are presented to the user, the server can receive a first response from the invitee accepting all occurrences of the recurring event. In some cases, the server can receive a first response from the invitee accepting a proper subset of all occurrences of the recurring event (912). A response accepting a proper subset of all occurrences means that at least one occurrence is not accepted in the response. If the server supplies the list of conflicting occurrences to the invite, the response can include just an indication as to whether a first option to accept all occurrences is selected by the invite, or a second option to accept only available occurrences is selected by the invitee. The server can determine which occurrences are accepted and which occurrences have not been accepted in this response based on the list of conflicting occurrences that the server has compiled.

After the server receives the first response from the invite, the server can send the first response to the organizer (914). The server can also update the status of the occurrences in the organizer's calendar to indicate which occurrences have been accepted by the invite, and which occurrences are still awaiting a response.

After the server receives the invitee's selection to accept all occurrences, the server can insert all occurrences into the invitee's calendar, despite the scheduling conflicts. If the invitee chose to accept only the non-conflicting occurrences, the server can insert just those non-conflicting occurrences into the invitee's calendar. The server can also send an individual notification to the invitee for each of the one or more occurrences that cause scheduling conflicts in the invitee's calendar (916). The individual notification can include a preview of a respective schedule conflict for the occurrence.

When the invitee reviews the individual notifications, the invitee can make an independent decision regarding each of the conflicting occurrences. When the invitee makes a decision regarding one of the notifications, a second response can be received from the invitee for one of the one or more conflicting occurrences (918). The second response can be one of accepting the occurrence, rejecting the occurrence, and holding the occurrence for further consideration, for example.

After the server receives the second response for a conflicting occurrence, the server can send the second response to the organizer (920). In some implementations, the server can update the status of the conflicting occurrence in the organizer's calendar, indicating the invitee's response to accept, rejection, or hold for further consideration. In some implementations, if the response is for rejecting the occurrence, the server can provide further user interfaces for proposing a new time for the rejected occurrence.

### Example System Architecture

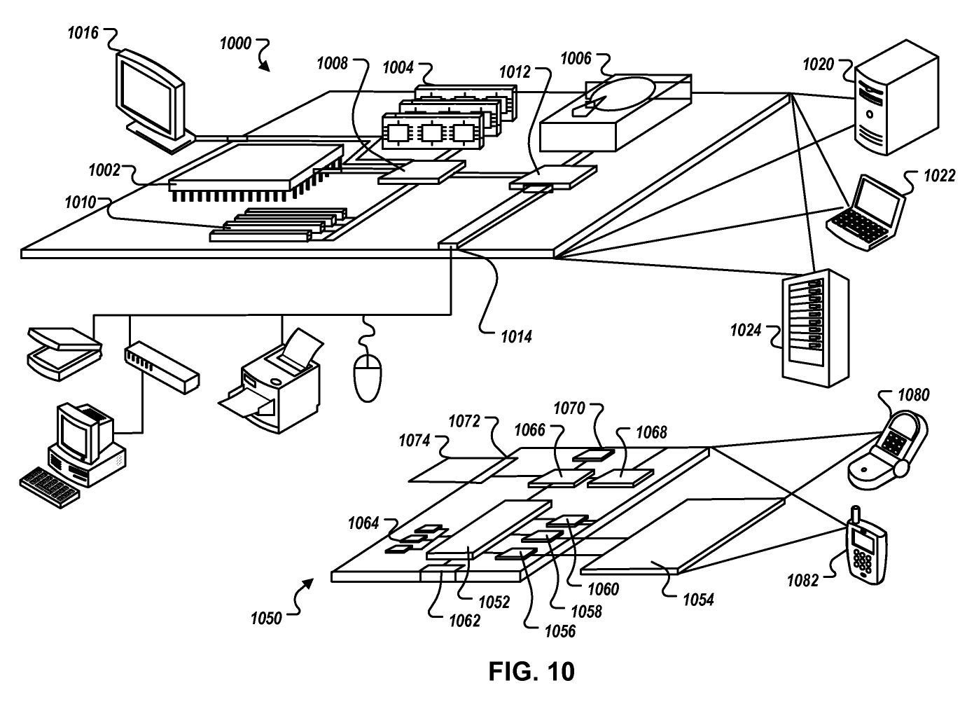

FIG. 10 is a block diagram of computing devices 1000, 1050 that may be used to implement the systems and methods described in this document, as either a client or as a server or plurality of client and servers. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface 1008 connecting to memory 1004 and high-speed expansion ports 1010, and a low speed interface 1012 connecting to low speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a computer-readable medium. In one implementation, the memory 1004 is a volatile memory unit or units. In another implementation, the memory 1004 is a non-volatile memory unit or units.

The storage device 1006 is capable of providing mass storage for the computing device 1000. In one implementation, the storage device 1006 is a computer-readable medium. In various different implementations, the storage device 1006 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1004, the storage device 1006, or memory on processor 1002.

The high speed controller 1008 manages bandwidth-intensive operations for the computing device 1000, while the low speed controller 1012 manages lower bandwidth-intensive operations. Such allocation of duties is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can process instructions for execution within the computing device 1050, including instructions stored in the memory 1064. The processor may also include separate analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD display or an OLED display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication (e.g., via a docking procedure) or for wireless communication (e.g., via Bluetooth or other such technologies).

The memory 1064 stores information within the computing device 1050. In one implementation, the memory 1064 is a computer-readable medium. In one implementation, the memory 1064 is a volatile memory unit or units. In another implementation, the memory 1064 is a non-volatile memory unit or units. Expansion memory 1074 may also be provided and connected to device 1050 through expansion interface 1072, which may include, for example, a SIMM card interface. Such expansion memory 1074 may provide extra storage space for device 1050, or may also store applications or other information for device 1050. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS receiver module 1070 may provide additional wireless data to device 1050, which may be used as appropriate by applications running on device 1050.

Device 1050 may also communication audibly using audio codec 1060, which may receive spoken information from a user and convert it to usable digital information. Audio codex 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smartphone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the search systems and methods have been described, it should be recognized that numerous other applications are contemplated. Accordingly, other embodiments are within the scope of the following claims.

What is claimed is:

1. A computer-implemented method, comprising:
presenting an invitation for a recurring event, the recurring event comprising a plurality of occurrences;
detecting scheduling conflicts for one or more of the plurality of occurrences with one or more existing events in a calendar; and
requesting, by a processor, a user to select between a first option to accept all occurrences and a second option to accept only non-conflicting occurrences of the recurring event, the non-conflicting occurrences being the occurrences that cause no scheduling conflicts in the calendar.

2. The method of claim 1, further comprising:
upon receiving the user's selection of the first option, inserting all occurrences of the recurring event into the calendar.

3. The method of claim 2, further comprising:
prior to inserting all occurrences of the recurring event into the calendar, presenting a preview of the detected scheduling conflicts.

4. The method of claim 1, further comprising:
upon the user's selection of the second option, inserting only the non-conflicting occurrences of the recurring event into the calendar.

5. The method of claim 4, further comprising:
sending a response to an organizer of the recurring event, the response indicating that only the non-conflicting occurrences of the recurring event have been accepted.

6. The method of claim 4, further comprising:
presenting a respective notification for each of the one or more occurrences that cause scheduling conflicts in the calendar, the notification presents a preview of a respective scheduling conflict for the occurrence.

7. The method of claim 6, further comprising:
receiving, through the notification for one of the one or more occurrences, user input individually accepting the occurrence.

8. The method of claim 6, further comprising:
receiving, through the notification for one of the one or more occurrences, user input individually rejecting the occurrence.

9. The method of claim 6, further comprising:
receiving, through the notification for one of the one or more occurrences, user input individually suggesting an alternative time for the occurrence.

10. The method of claim 1, wherein the invitation for the recurring event represents a reservation request for an event venue.

11. A computer-implemented method, comprising:
sending an invitation for a recurring event, the recurring event comprising a plurality of occurrences;
receiving a first response accepting a proper subset of all occurrences of the recurring event;
receiving a second response for one of the remaining occurrences of the recurring event, the second response being one of accepting the occurrence, rejecting the occurrence, or holding the occurrence for further consideration; and
presenting, by a processor, the first and the second responses in a calendar including the recurring event.

12. A computer-implemented method, comprising:
receiving an invitation for a recurring event from an organizer to an invite, the invitation specifying a recurrence frequency of the recurring event;
expanding the recurring event into a plurality of occurrences according to the specified recurrence frequency;
detecting, by a processor, scheduling conflicts for one or more of the plurality of occurrences with one or more existing events in a calendar of the invitee;
sending the invitation for the recurring event to the invitee; and
notifying the invitee of the scheduling conflicts for the one or more occurrences.

13. The method of claim 12, further comprising:
receiving a first response from the invitee accepting a proper subset of all occurrences of the recurring event, the proper subset being the occurrences that do not cause scheduling conflicts in the calendar of the invitee; and
sending the first response to the organizer.

14. The method of claim 13, further comprising:
sending an individual notification to the invitee for each of the one or more occurrences that cause scheduling conflicts in the calendar of the invite, the notification presenting a preview of a respective scheduling conflict for the occurrence.

15. The method of claim 14, further comprising:
receiving a second response from the invitee for one of the one or more occurrences in response to the individual notification for the occurrence, the second response being one of accepting the occurrence, rejecting the occurrence, and holding the occurrence for further consideration; and
sending the second response to the organizer.

16. The method of claim 12, wherein the calendar of the invitee integrates multiple sources of availability information for the invitee.

17. The method of claim 12, wherein the recurrence frequency has an associated time period, and the expanding is performed for the associated time period.

18. The method of claim 12, wherein the detecting further comprises:
detecting an overlap in schedule time between one of the one or more occurrences and one of the one or more existing events in the calendar of the invitee; and
determining that the occurrence of the recurring event and the existing event are incompatible with each other during the overlap in schedule time.

19. A computer-readable medium having instructions stored thereon, which, when executed by a processor, cause the processor to perform operations comprising:
receiving an invitation for a recurring event from an organizer to an invite, the invitation specifying a recurrence frequency of the recurring event;
expanding the recurring event into a plurality of occurrences according to the specified recurrence frequency;
detecting scheduling conflicts for one or more of the plurality of occurrences with one or more existing events in a calendar of the invitee;
sending the invitation for the recurring event to the invitee; and
notifying the invitee of the scheduling conflicts for the one or more occurrences.

20. A system, comprising:
one or more processors;
memory coupled to the one or more processors and operable for storing instructions, which, when executed by the one or more processors, cause the one or more processors to perform operations, comprising:
receiving an invitation for a recurring event from an organizer to an invite, the invitation specifying a recurrence frequency of the recurring event;
expanding the recurring event into a plurality of occurrences according to the specified recurrence frequency;
detecting scheduling conflicts for one or more of the plurality of occurrences with one or more existing events in a calendar of the invitee
sending the invitation for the recurring event to the invitee and
notifying the invitee of the scheduling conflicts for the one or more occurrences.
